(19) United States
(12) Patent Application Publication
(10) Pub. No.: US 2011/0185509 A1
(43) Pub. Date: Aug. 4, 2011

(54) Patient Immersion Control

(76) Inventor: David M. Genaro, North Lauderdale, FL (US)

(21) Appl. No.: 12/700,451

(22) Filed: Feb. 4, 2010

(51) Int. Cl. A47C 27/08; A47C 27/00; G08B 21/00

(52) U.S. Cl. 5/713; 5/690; 340/540

(57) ABSTRACT

A mattress includes a base member, a support surface disposed on the base member, and a proximity control system cooperable the support surface and the base member. The proximity control system controls immersion of an object on the support surface.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND OF THE INVENTION

Support surfaces are used for patients that are susceptible to wounds caused by continuous pressure on any part of the body. When a patient utilizes a support surface made of materials such as air, foam, or gel, there is a likelihood of “bottoming out.” On an air or pneumatic support surface, bottoming out occurs when the air cells in a given zone, or individual cells, contain insufficient pressure to support the weight that is on them. This results in the patient coming in direct contact with the subsurface beneath the air cells. The subsurface could be a foam substrate or even the bed frame itself. Such direct contact compromises the provided pressure relief and allows high and continuous pressure points on the patient's skin, which can lead to skin breakdown.

On a foam support surface, the patient bottoms out when either (1) the patient is too heavy for the particular design of that foam mattress, i.e., the density and ILD of the foam itself is not sufficient to fully support the patient without bottoming out, or (2) due to the age of the surface, the foam has lost its ability to provide proper support.

When caring for bedridden patients on a pneumatic support surface, one of the caregiver's important duties is to ensure that the patient is not “bottoming out.” To ensure this, the mattress pressures must be set to accommodate the patient in a variety of positions. This often results in cell pressures that are set higher than what is required to support the patient and to provide optimal therapy.

It is therefore desirable to have a device that can adjust the pressure if bottoming out is occurring, but without keeping pressures artificially high. It is also desirable to have a device, particularly for a foam mattress, that would activate an alarm if the patient bottomed out. This would indicate the wrong mattress for the patient.

### BRIEF SUMMARY OF THE INVENTION

In a preferred embodiment, a proximity sensor is installed in a mattress. The proximity sensor can determine the distance between the patient and the top of the underlying foam support substrate. When a signal is received from the sensor that the patient is close to bottoming, the pressure can be adjusted automatically, maintaining a specified minimum clearance, and thus maintaining the correct pressures for optimum therapy while preventing the constant higher pressure when not needed. The system alleviates the necessity of manually increasing trunk pressures when the head of the bed is inclined, known as the “Fowler Position.” This position shifts much of the load weight to the trunk section, and makes bottoming out more likely. The present embodiments can also be utilized on a foam mattress, which would sound an alarm if bottoming out occurs or is close to occurring.

In an exemplary embodiment, a mattress includes a base member, a support surface including at least one inflatable air cell disposed on the base member, and a source of pressurized air in fluid communication with the at least one inflatable air cell. A proximity sensor is disposed between the base member and the support surface, and a processor that communicates with the proximity sensor and the source of pressurized air is programmed to activate the source of pressurized air according to a signal from the proximity sensor.

The base member may be a bed frame, a foam substrate or an alternative member. The proximity sensor is preferably a capacitance circuit that measures a change in capacitance based on the distance between a conductive object on the support surface and the base member. The mattress may still further include an alarm communicating with the processor, where the processor activates the alarm according to a signal from the proximity sensor.

In another exemplary embodiment, a method of controlling immersion of an object on a mattress includes the steps of (a) measuring a proximity between the object on the mattress and the base member with the proximity sensor, and (b) if the proximity is less than a predetermined distance, the processor activating the source of pressurized air to inflate the at least one inflatable air cell. Preferably, the proximity sensor is a capacitance circuit, and step (a) is practiced by measuring a change in capacitance based on the distance between the object positioned on the support surface and the base member. The method may include, prior to step (a), presetting an immersion limit for the object. In this context, the presetting step may comprise measuring a reference capacitance with the object in contact with the base member and measuring a max inflate capacitance with the at least one inflatable air cell completely inflated, and presetting a target capacitance based on a linear capacitance relationship between the reference capacitance and the max inflate capacitance.

In yet another exemplary embodiment, a mattress includes a base member, a support surface disposed on the base member, and a proximity control system cooperable the support surface and the base member. The proximity control system controls immersion of an object on the support surface.

### BRIEF DESCRIPTION OF THE DRAWINGS

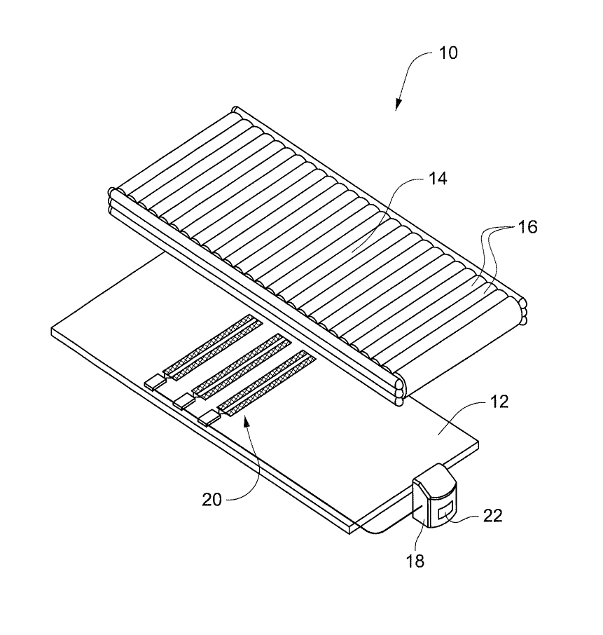

These and other aspects and advantages will be described in detail with reference to the accompanying drawing, in which FIG. 1 is a perspective view of the mattress according to preferred embodiments.

### DETAILED DESCRIPTION OF THE INVENTION

With reference to the drawings, a mattress 10 includes a base member 12, a support surface 14 including at least one inflatable air cell 16 disposed on the base member, and a source of pressurized air 18 in fluid communication with the inflatable air cell(s) 16. A proximity sensor 20 is disposed between the base member 12 and the support surface 14. A processor 22 communicates with the proximity sensor 20 and the source of pressurized air 18. The processor is programmed to activate the source of pressurized air 18 according to a signal from the proximity sensor 20. The support surface 14 may be a foam substrate or a bed frame or the like.

Preferably, the system includes one or more capacitive (or other type) proximity sensors 20. The patient or other object supported on the mattress completes the capacitance circuit. The sensing circuits 20 measure the change in capacitance and report back to the processor 20. The data is passed through an algorithm to determine the patient's immersion level at each sensor 20 (i.e., the “proximity” of the body to the base member). This immersion or proximity is then passed on to the air source 18, which updates the target pressures and increases the air cell pressure as needed.

There are several different circuits that can be employed to measure the change in capacitance for the proximity sensor(s) 20. For example: (1) an oscillator circuit—as the capacitor charges and discharges (oscillation), it changes its frequency, which frequency change can be measured; (2) pulse width—as the capacitor charges and discharges, the pulse width changes, which can also be measured; (3) an RC (resistor/capacitor) time constant—the charging factor of an RC time constant circuit can be measured; or (4) etc. The capacitance sensing elements could be a carbon impregnated wire or even such material as Tyvex with carbon printing.

Another convenient feature of the system is that the change in capacitance, for each individual patient, required before the electronic controller reacts could be pre-set or “learned.” This could be done by measuring the capacitance when in fact the patient's body is bottoming out, i.e., the body is touching the bottom of the mattress. This will be a measure of the high capacitance indicating “low” height off the bed. Then, the mattress could be completely inflated, often called “Max Inflate.” The capacitance would then be measured, which would be the low reading for capacitance for a large distance or height away from the bed bottom. The equation used by the proximity sensors 20, capacitance vs. distance, is linear. Therefore, the pre-set readings can easily be obtained and used effectively to always prevent bottoming out for any weight patient. This is in effect a “Learn Mode” the user can utilize to custom set the device.

The prior discussion was of capacitance type proximity sensors. This type is very common and would work well for the present invention. However, the present invention is by no means limited to capacitance type proximity sensors. Other types of proximity sensors could be utilized just as easily and effectively. Some examples (besides capacitance) include inductive, eddy current, magnetic, photo cell, laser range finder, sonar proximity sensors, and the like. For example, the magnetic proximity sensor could work by having small flat magnets on the bottom of the mattress, next to the bed frame, and on the underside of the top cover of the mattress. The magnetic field would change as the air cells or foam expanded or contracted (bottomed out). This change can be measured and utilized by the electronic controller.

In all these types of proximity sensors, the present invention uses the predictable nature of proximity sensors to determine the distance the patient's body is from the bottom of the bed. With this information the system can react by sounding an alarm or by increasing air pressure to raise the patient's body off the bottom.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A mattress comprising:
a base member;
a support surface including at least one inflatable air cell disposed on the base member;
a source of pressurized air in fluid communication with the at least one inflatable air cell;
a proximity sensor disposed between the base member and the support surface; and
a processor communicating with the proximity sensor and the source of pressurized air, wherein the processor is programmed to activate the source of pressurized air according to a signal from the proximity sensor.

2. A mattress according to claim 1, wherein the base member is a bed frame.

3. A mattress according to claim 1, wherein the base member is a foam substrate.

4. A mattress according to claim 1, wherein the proximity sensor comprises a capacitance circuit that measures a change in capacitance based on a distance between a conductive object on the support surface and the base member.

5. A mattress according to claim 1, further comprising an alarm communicating with the processor, the processor activating the alarm according to a signal from the proximity sensor.

6. A method of controlling immersion of an object on a mattress, the mattress including a base member, a support surface including at least one inflatable air cell disposed on the base member, a source of pressurized air in fluid communication with the at least one inflatable air cell, a proximity sensor disposed between the base member and the support surface, and a processor communicating with the proximity sensor and the source of pressurized air, the method comprising:
(a) measuring a proximity between the object on the mattress and the base member with the proximity sensor; and
(b) if the proximity is less than a predetermined distance, the processor activating the source of pressurized air to inflate the at least one inflatable air cell.

7. A method according to claim 6, wherein the proximity sensor is a capacitance circuit, and wherein step (a) is practiced by measuring a change in capacitance based on a distance between the object positioned on the support surface and the base member.

8. A method according to claim 7, further comprising, prior to step (a), presetting an immersion limit for the object.

9. A method according to claim 8, wherein the presetting step comprises measuring a reference capacitance with the object in contact with the base member and measuring a max inflate capacitance with the at least one inflatable air cell completely inflated, and presetting a target capacitance based on a linear capacitance relationship between the reference capacitance and the max inflate capacitance.

10. A mattress comprising a base member, a support surface disposed on the base member, and a proximity control system cooperable the support surface and the base member, the proximity control system controlling immersion of an object on the support surface.

11. A mattress according to claim 10, wherein the base member is a bed frame.

12. A mattress according to claim 10, wherein the base member is a foam substrate.

13. A mattress according to claim 10, wherein the proximity control system comprises:
a source of pressurized air in fluid communication with an inflatable air cell of the support surface;
a proximity sensor disposed between the base member and the support surface; and
a processor communicating with the proximity sensor and the source of pressurized air, wherein the processor is programmed to activate the source of pressurized air according to a signal from the proximity sensor.

14. A mattress according to claim 13, wherein the proximity sensor comprises a capacitance circuit that measures a change in capacitance based on a distance between the object on the support surface and the base member.
